(19) United States
(12) Patent Application Publication
(10) Pub. No.: US 2022/0258822 A1
(43) Pub. Date: Aug. 18, 2022

(54) DRIVE MODULE FOR A SMALL OR MINI VEHICLE, AND SMALL OR MINI VEHICLE HAVING THE DRIVE MODULE

(71) Applicant: Schaeffler Technologies AG & Co. KG, Herzogenaurach (DE)

(72) Inventors: Simon ORTMANN, Baden-Baden (DE); Philippe WAGNER, Souffelweyersheim (FR); Yannick WEY, Hoerdt (FR)

(73) Assignee: Schaeffler Technologies AG & Co. KG, Herzogenaurach (DE)

(21) Appl. No.: 17/625,847

(22) PCT Filed: Jun. 17, 2020
(86) PCT No.: PCT/DE2020/100514

§ 371 Date: Jan. 10, 2022

(30) Foreign Application Priority Data
Jul. 10, 2019 (DE) 10 2019 118 694.3

(51) Int. Cl. B62H 5/18; B62J 45/40; B62K 3/00

(52) U.S. Cl. CPC B62H 5/18; B62K 2204/00; B62K 3/002; B62J 45/40

(57) ABSTRACT

A drive module (1) for a small or mini vehicle (20), having a wheel axle (8), at least one wheel (2, 3), at least one motor device (4, 5) for producing and applying a drive torque to the at least one wheel (2, 3), and at least one braking device (6, 7) for braking the at least one wheel (2, 3). The drive module (1) further includes an evaluation and control device (12) for evaluating safety-relevant data (30) of the small or mini vehicle (20) and for controlling the drive module (1) on the basis of the evaluated safety-relevant data (30) and/or can be and/or is connected to the evaluation and control device.

### CROSS-REFERENCE TO RELATED APPLICATIONS

This application is the U.S. National Phase of PCT Appln. No. PCT/DE2020/100514, filed Jun. 17, 2020, which claims priority from German Patent Application No. 10 2019 118 694.3, filed Jul. 10, 2019, the entire disclosures of which are incorporated by reference herein.

### TECHNICAL FIELD

The disclosure relates to a drive module for a small or mini vehicle, comprising a wheel axle, at least one wheel, at least one motor device for producing and applying a drive torque to the at least one wheel, and at least one braking device for braking the at least one wheel. The disclosure also relates to a small or mini vehicle having the drive module.

### BACKGROUND

E-scooters are increasingly being used as a means of transport in road traffic. Solutions are being sought to increase safety when driving e-scooters. It is already known to switch off a drive of an e-scooter if it exceeds a permissible total loading weight.

For example, DE 20 2019 001 096 U1, which probably constitutes the closest background of the art, describes an e-scooter having an electric drive and having a control system for controlling the drive and for informing a user about a state of the e-scooter. A weight of the user including baggage is determined and compared with a permissible weight. The user is shown the result of the comparison on an information panel. If the weight is too high, the control system switches off the electric drive.

### SUMMARY

The disclosure is based on the object of providing a compact, robust and safety-optimized drive module for a small or mini vehicle. This object is achieved by a drive module for a small or mini vehicle with one or more of the features disclosed herein and by a small or mini vehicle having the drive module. Preferred or advantageous embodiments result from the claims, the following description and/or the attached figures.

A drive module for a small or mini vehicle is proposed. Preferably, the small or mini vehicle is particularly designed as a multi-track electric vehicle. The vehicle is particularly preferably designed as a scooter, in particular as an electric motorcycle, electric pedal scooter, electric scooter, for example an e-scooter, as a Segway, hoverboard, kickboard, longboard or the like. The vehicle can alternatively be designed as a multi-track bicycle, in particular having three or more wheels. For example, the vehicle may be a transport or cargo bike, in particular a motorized or electrically powered transport or cargo bike, more specifically a three-wheeled or four-wheeled pedelec or a rickshaw, in particular with or without a roof, or a cabin scooter.

The drive module comprises a wheel axle, in particular a transverse wheel axle. Preferably, the wheel axle is designed as a rear wheel axle, but it can alternatively be designed as a front wheel axle as well. Preferably, the wheel axle has a mechanical interface for fastening to a frame or chassis of the small or mini vehicle.

The drive module has at least one wheel and at least one motor device, in particular at least one electric motor. The at least one motor device is designed to produce a drive torque and apply same to the at least one wheel. The drive module further comprises at least one braking device designed to brake the at least one wheel.

According to the disclosure, the drive module comprises an evaluation and control device for evaluating safety-relevant data of the small or mini vehicle and for controlling the drive module on the basis of the evaluated safety-relevant data. Alternatively or optionally in addition, the drive module can be and/or is connected to said evaluation and control device.

Advantageously, safe driving with the small or mini vehicle can be ensured by controlling the drive module integrated into the small or mini vehicle on the basis of the evaluated safety-relevant data. In particular, dangerous situations in road traffic can be reduced when driving the small or mini vehicle, thereby avoiding accidents and resulting injuries and damage.

In a particularly preferred embodiment, the wheel axle carries a first wheel, a first motor device and a first braking device and a second wheel, a second motor device and a second braking device of the drive module. Preferably, the first wheel, the first motor device and the first braking device form a first compact unit arranged at one end of the wheel axle. In particular, the second wheel, the second motor device and the second braking device form a second compact unit arranged at another end of the wheel axle. Preferably, the mechanical interface in this arrangement is located centrally between the two units. Advantageously, a high integration density of the braking devices and the motor devices can be achieved. Preferably, the units have a resistant and robust construction and are thus well protected against vandalism.

A possible constructive implementation provides that the motor devices are integrated into the respective wheel, for example designed as a wheel hub motor. Preferably, the braking devices are arranged to be axially adjacent to the respective wheel and/or the respective motor device. For example, the braking devices can be activated manually by a driver of the small or mini vehicle. For this purpose, the braking devices can be connected, for example via a line, to a hand lever by means of which they can be actuated hydraulically. The hand lever is arranged, for example, on a handlebar of the small or mini vehicle.

Optionally, a single central evaluation and control device is provided for the drive module, in particular for controlling the two units. Alternatively, two evaluation and control devices can be provided, wherein each of the units is assigned its own evaluation and control device. For this purpose, the evaluation and control device(s) can be arranged on the wheel axle and connected to the units or they can be directly integrated into the corresponding unit.

In a preferred embodiment, the drive module comprises an activation device designed to activate the braking device. Preferably, the control device controls the activation device to activate the braking device to brake the at least one wheel. In particular, the activation device is designed and/or can be activated independently of the manually operated hand lever.

For example, the activation device can be a cable, a linkage or a hydraulic device that is operatively connected to the at least one braking device. In particular, the braking device can thereby be activated in dependence on the safety-relevant data and the small or mini vehicle can be braked or brought to a standstill if the drive module is integrated into the small or mini vehicle. For example, the driving speed of the small or mini vehicle can thereby be adapted automatically and/or autonomously, in particular without manual intervention by the driver, to the conditions of the road traffic. Optionally, emergency braking of the small or mini vehicle can also be triggered, for example to avoid a collision.

In one possible implementation, the control device controls the motor device to increase or decrease the drive torque. If the drive module is integrated into the small or mini vehicle, the driving speed of the small or mini vehicle can be adjusted automatically and/or autonomously depending on the safety-relevant data, in particular without intervention by the driver. In particular, the speed of the small or mini vehicle can be adapted to the conditions of the road traffic. For example, excessive speed of the small or mini vehicle can be avoided and safety risks caused by this can be limited.

Another possible embodiment provides that the control device controls a switch-off of the motor device when the braking device is activated. Preferably, the motor device is deactivated automatically and/or autonomously, in particular without intervention by the driver, when its power is not required due to the braking of the at least one wheel. In particular, this allows an automatic switch-off to be implemented in the small or mini vehicle if the drive module is integrated into the small or mini vehicle. Advantageously, this can reduce energy consumption of the motor device and ensure a longer service life of the small or mini vehicle.

A further object of the disclosure is a small or mini vehicle having the drive module according to the previous description.

Preferably, the small or mini vehicle comprises the chassis or frame, the handlebar and/or the hand lever. Preferably, the small or mini vehicle has at least one additional wheel. For example, the at least one additional wheel is a front wheel that can be steered with the handlebar. However, it can also be at least one rear wheel if the drive module comprises the front wheel axle of the vehicle as the wheel axle.

Optionally, the chassis or frame has a step and/or standing surface for the rider. Preferably, the driver stands on the step and/or standing surface when driving the small or mini vehicle. Alternatively or optionally in addition, the chassis or the frame may have a saddle or seat for the driver to sit on when riding the small or mini vehicle. Preferably, a counter-interface for the mechanical interface of the wheel axle of the drive module is arranged on the chassis or the frame. In particular, the drive module is connected to the chassis or the frame via the interface and counter-interface.

In a preferred embodiment, the small or mini vehicle comprises at least one sensor device which is designed to detect the weight of a person and/or load of the small or mini vehicle as the safety-relevant data. Alternatively or optionally in addition, the small or mini vehicle can be and/or is connected to the at least one sensor device. Preferably, the at least one sensor device is connected to the evaluation and control device of the drive module by cable or wirelessly. In particular, the at least one sensor device transmits the weight of a person and/or load as the safety-relevant data to the evaluation and control device. For example, the at least one sensor device is designed as a pressure and/or weight sensor for detecting the weight of a person and/or load. The at least one sensor device can, for example, be arranged in the step and/or standing surface, in the saddle or in the seat surface or in the counter-interface.

Preferably, the weight of a person and/or load is evaluated as the safety-relevant data by the evaluation and control device. For example, at least one threshold value for the weight of a person and/or load can be stored in the evaluation and control device, and if this threshold value is exceeded or not reached, the corresponding control activations of the at least one motor device and/or the at least one activation device can be effected.

For example, the evaluation and control device controls the at least one motor device based on the weight of a person and/or load. This allows the drive torque to be adapted to the weight of a person and/or load, in particular to be increased or reduced as required. Optionally in addition or alternatively, the evaluation and control device controls the at least one activation device for activating the at least one braking device as a function of the weight of a person and/or load. For example, the braking device can be activated or the braking force can be increased if required. Control of emergency braking is also possible within the scope of the disclosure. In particular, during automatic and/or autonomous braking, optimum performance of the at least one motor device can be achieved without endangering the driver.

In one possible embodiment, the small or mini vehicle comprises a position-determining device designed to determine the position of the small or mini vehicle as the safety-relevant data. Alternatively or optionally in addition, the small or mini vehicle can be and/or is connected to the position-determining device. Preferably, the position-determining device is connected to the evaluation and control device of the drive module by cable or wirelessly. In particular, the position-determining device transmits the position of the small or mini vehicle as the safety-relevant data to the evaluation and control device. For example, the position-determining device may be designed as a GPS receiver and/or a navigation device.

Alternatively, the position-determining device can also be designed as an electronic mobile device carried in the small or mini vehicle, for example as a smartphone, in particular having location and/or navigation services. Preferably, the mobile device can be coupled to the small or mini vehicle in such a way that it can be used as the position-determining device and its battery can be charged at the same time as the small or mini vehicle is being driven. For this purpose, in a preferred embodiment, the small or mini vehicle has a suitable coupling and/or charging interface for the mobile device.

In a preferred implementation, the evaluation and control device controls the at least one motor device and/or the at least one activation device to activate the at least one braking device depending on the position of the small or mini vehicle. This can be used to ensure that the small or mini vehicle adheres to a prescribed and/or adapted speed, for example in a 30 km/h zone, pedestrian zone or play street. For example, when driving on a steep incline or descent, the at least one activation device can be activated and/or the drive torque of the at least one motor device can be adjusted. Thus, the at least one wheel of the drive module can be braked automatically and/or autonomously, in particular without intervention by the driver, by the at least one activated braking device. Optionally in addition or alternatively, the at least one wheel of the drive module can be braked automatically and/or autonomously, in particular without intervention by the driver, by the reduced drive torque.

In one possible embodiment, the small or mini vehicle comprises a personal identification device for identifying the driver of the small or mini vehicle, in particular for identifying a registered and/or licensed driver by means of a code or by means of his name, date of birth, place of residence, etc. and/or by means of biometric data, such as a fingerprint, facial and/or eye scan, etc. as the safety-relevant data. Alternatively or optionally in addition, the personal identification device can be and/or is connected to the small or mini vehicle. The personal identification device can be designed as an input and/or output device, for example as a touchscreen. Alternatively, the electronic mobile device, for example the smartphone, can be used as the personal identification device.

A preferred embodiment provides that the evaluation and control device of the drive module controls the at least one motor device and/or the at least one activation device for activating the at least one braking device based on the person identified as the driver. In particular, the evaluation and control device compares the person identified as the driver with a database stored in the evaluation and control device in which all authorized drivers are registered. For example, the evaluation and control device can automatically and/or autonomously block or release the start-up of the small or mini vehicle. For this purpose, it can only activate the at least one motor device if the identified driver is registered in the database as an authorized driver. It is also possible within the scope of the disclosure that the evaluation and control device controls the drive torque of the at least one motor device depending on the age and/or driving experience of the identified driver. For example, the small or mini vehicle can be throttled and, in particular, a maximum speed can be adapted automatically and/or autonomously to the age or experience of the identified driver. It is also conceivable within the scope of the disclosure that the at least one motor device is automatically and/or autonomously deactivated when the identified driver has traveled a certain distance and/or for a certain travel time or when a certain distance and/or travel zone is not permitted for entry or passage. The aforementioned control models can offer particularly interesting solutions for vehicle sharing providers, for example.

Another possible implementation provides that the small or mini vehicle comprises an output device for outputting a visual and/or acoustic information and/or warning signal. Alternatively or optionally in addition, the small or mini vehicle can be and/or is connected to the output device. For example, the output device is designed as a screen, display or touch screen. However, the output device can also be realized via the electronic mobile device, for example via the smartphone. On the output device, the driver can be shown, for example, a release or a prohibition to use the small or mini vehicle and/or any restrictions regarding the maximum speed and/or the driving distance etc. based on his personal identification. References to applicable traffic regulations, such as speeds to be observed, regarding certain roads or zones or indications of exceeding the permissible weight of a person and/or load on the small or mini vehicle are also possible within the scope of the disclosure.

### BRIEF DESCRIPTION OF THE DRAWINGS

Further features, advantages and effects of the disclosure are set out in the following description of the preferred embodiments. In the figures:

FIG. 1 shows a perspective side view of a small or mini vehicle having a drive module; and

FIG. 2 shows the drive module from FIG. 1.

### DETAILED DESCRIPTION

Parts that correspond to each other or are identical are marked with the same reference symbols in the figures.

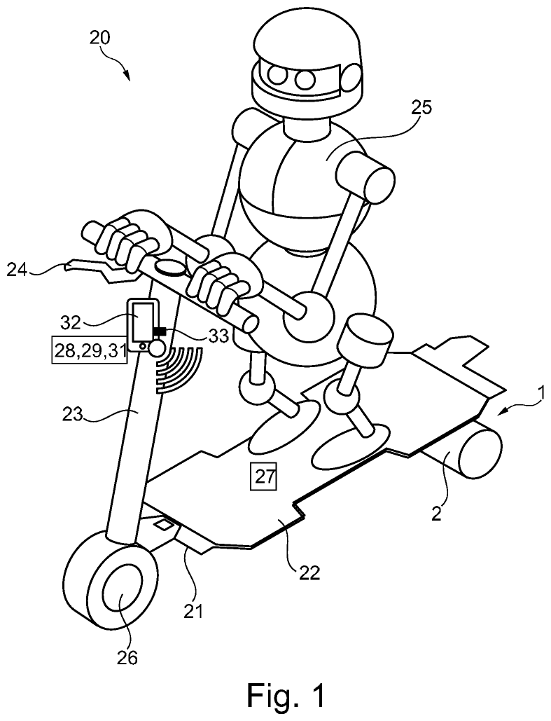

FIG. 1 shows a small or mini vehicle 20 in a perspective side view. The small or mini vehicle 20 is designed as a three-track electric scooter, in particular as an e-scooter. The small or mini vehicle 20 has a frame 21 having a step and standing surface 22 and a handlebar 23. A hand lever 24 is arranged on the handlebar 23 for manual braking of the small or mini vehicle 20 by a driver 25. The small or mini vehicle 20 comprises a front wheel 26 steerable by the handlebar 23 and a drive module 1 forming a rear wheel axle of the small or mini vehicle 20.

The small or mini vehicle 20 comprises at least one sensor device 27 and/or can be and/or is connected to the at least one sensor device 27. The at least one sensor device 27 is designed to detect a weight of a person and/or load as safety-relevant data 30 of the small or mini vehicle 20. The at least one sensor device 27 is designed as at least one pressure and/or weight sensor. According to FIG. 1, the at least one sensor device 27 is integrated into the step and standing surface 22, but it can alternatively also be arranged at a counter-interface of the small or mini vehicle 20 in which the drive module 1 is fastened to the frame 21.

The small or mini vehicle 20 further comprises and/or can be and/or is connected to a position-determining device 28. The position-determining device 28 is designed to determine a position of the small or mini vehicle 20 as the safety-relevant data 30. The position-determining device 28 is integrated into an electronic mobile device 32, for example a smartphone, as shown in FIG. 1. It can alternatively be designed as a GPS or navigation device.

The small or mini vehicle 20 also comprises and/or can be and/or is connected to a personal identification device 29. The personal identification device 29 is designed to identify the person of the driver 25 by means of a code or by means of his name, date of birth, place of residence, etc. and/or by means of biometric data, such as a fingerprint, facial and/or eye scan, etc. as the safety-relevant data 30. The personal identification device 29 is integrated into the mobile device 32. In an alternative exemplary embodiment, the personal identification device 29 may also be designed as an input and/or output device, for example a touch screen.

The small or mini vehicle 20 also has an output device 31 which is designed to output a visual and/or acoustic information and/or warning signal. According to FIG. 1, the electrical device 32 is used as the output device 31. In an alternative exemplary embodiment, however, a screen, display or touch screen can also be provided as the output device 31.

The small or mini vehicle 20 comprises a coupling interface 33 for coupling the mobile device 32, in particular the smartphone. For example, the coupling interface 33 is arranged on the handlebar 23 so that it is easily visible and accessible to the driver. The mobile device 32 can thus be securely coupled to the small or mini vehicle, carried along and used while driving. A battery of the mobile device 32 can be charged while driving using the coupling interface 33.

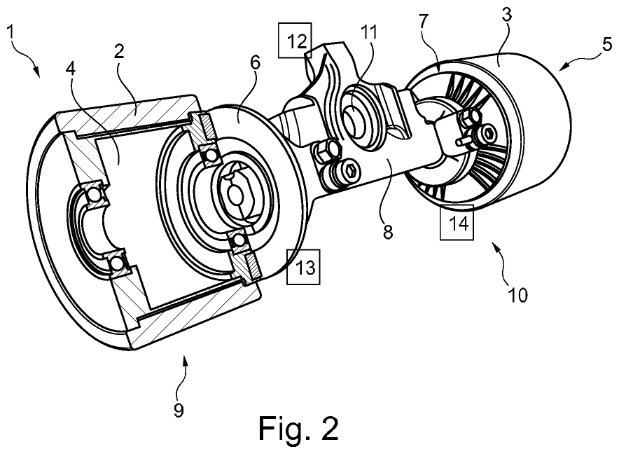

FIG. 2 shows the drive module 1 in a perspective top view from the front. It comprises at least one wheel, in particular a first wheel 2 and a second wheel 3. The drive module 1 has at least one motor device designed as an electric motor for producing and applying a drive torque to the at least one wheel, in particular a first motor device 4 and a second motor device 5. The drive module 1 further comprises at least one braking device for braking the at least one wheel, in particular a first braking device 6 and a second braking device 7 and a wheel axle 8, which is designed as a rear wheel transverse axle.

The first wheel 2 together with the first motor device 4 and with the first braking device 6 form a first compact unit 9. The first compact unit 9 is arranged at one end of the wheel axle 8 and/or is supported by it. To form the first compact unit 9, the first motor device 4 is integrated into the first wheel 2 as a wheel hub motor. The first braking device 6 is arranged to be directly axially adjacent to the first wheel 2. The second wheel 3 forms a second compact unit 10 together with the second motor device 5 and the second braking device 7. The second compact unit 10 is arranged at another end of the wheel axle 8 and/or is supported by it. To form the second compact unit 10, the second motor device 5 is integrated into the second wheel 3 as a wheel hub motor. The second braking device 7 is arranged to be directly axially adjacent to the second wheel 2. The two units 9, 10 are space-saving and particularly robust and resistant to external damage, for example against vandalism.

The wheel axle 8 has a mechanical interface 11 by means of which it can be and/or is fastened to the frame 21 of the small or mini vehicle 20 in the counter-interface. The mechanical interface 11 is arranged centrally between the two units 9, 10.

The drive module 1 comprises at least one activation device, in particular a first activation device 13 for activating the first braking device 6 and a second activation device 14 for activating the second braking device 7. For this purpose, the activation devices 14 are mechanically or hydraulically in operative connection with the braking devices 4, 5.

The drive module 1 further comprises an evaluation and control device 12 for evaluating the safety-relevant data 30 of the small or mini vehicle 20 and for controlling the drive module 1 on the basis of the evaluated safety-relevant data 29. The evaluation and control device 12 can be and/or is connected to the at least one sensor device 27 and to the position-determining device 28, to the person identification device 29 and/or to the output device 31, in particular to the electrical device 32, wirelessly or by cable.

If the drive module 1 as shown in Figure one is integrated into the small or mini vehicle 20 and forms the rear wheel axle there, the at least one sensor device 27, the position-determining device 28, the person identification device 29 and the output device 31 transmit the safety-relevant data 30 recorded by them to the evaluation and control device 12. The evaluation and control device 12 evaluates the safety-relevant data 30 received and controls the drive module 1 on the basis of the evaluated safety-relevant data 30.

The evaluation and control device 12 controls, in particular, the first and second motor devices 4, 5. In particular, the control and evaluation device 12 can activate or deactivate the first and second motor devices 4, 5 and/or control them to produce the drive torque determined according to the evaluated safety-relevant data 30. The motor devices 4, 5 are activated, for example, when the driver 25 has successfully identified himself and, as a result, permission to use the small or mini vehicle 20 has been evaluated. In particular, the motor devices 4, 5 remain deactivated if the driver 25 cannot prove that he is authorized to use the small or mini vehicle 20. Deactivation of the motor devices 4, 5 can also occur if it is evaluated that the weight of a person and/or load exceeds a permissible total weight for the small or mini vehicle 20. The motor devices 4, 5 can also be switched off when the braking devices 6, 7 are activated. This implements a so-called automatic switch-off in the small or mini vehicle 20.

The evaluation and control device 12 alternatively or optionally in addition controls the first and second activation devices 13, 14 to activate the first and second braking devices 6, 7. The control of the production of the determined drive torque and/or the control of the first and second activation devices 13, 14 is carried out, for example, when a maximum speed is specified at which the small or mini vehicle 20 is to travel. This can be implemented, for example, depending on an age limit if the identified driver 25 falls below same. However, compliance with a maximum speed and the corresponding activation of the motor devices 4, 5 and the activation device 13, 14 can also take place when the small or mini vehicle 20 drives on roads or through areas or zones where a speed limit is specified. In summary, an acceleration or deceleration of the driving speed of the small or mini vehicle 20 can take place depending on the evaluated safety-relevant data 30.

It is also possible for the evaluation and control device 12 to trigger an increased drive torque by the motor devices 4, 5 and/or control the activation devices 13, 14 to activate the braking devices 6, 7 if the evaluated weight of a person and/or load exceeds a threshold value or range stored in the evaluation and control device 12.

The evaluation and control device 12 can also control the output of the at least one information or warning signal on the output device 31. For example, the driver 25 can thereby be informed about the evaluated safety-relevant data 30 and/or the resulting control measures. For example, the driver can also be advised that a speed limit applies on the road, in the zone or area on/in which they are traveling in the small or mini vehicle 20.

### LIST OF REFERENCE SYMBOLS

1 Drive module
2 First wheel
3 Second wheel
4 First motor device
5 Second motor device
6 First braking device
7 Second braking device
8 Wheel axle
9 First compact unit
10 Second compact unit
11 Mechanical interface
12 Evaluation and control device
13 First activation device
14 Second activation device
20 Small or mini vehicle
21 Frame
22 Step and standing surface
23 Handlebar
24 Hand lever
25 Driver
26 Front wheel
27 Sensor device
28 Position-determining device
29 Personal identification device
30 Safety-relevant data
31 Output device
32 Mobile device
33 Coupling interface

1. A drive module for a small or mini vehicle, the drive module comprising:
a wheel axle;
at least one wheel;
at least one motor for producing and applying a drive torque to the at least one wheel; and
at least one braking device for braking the at least one wheel; and
an evaluation and control device configured to evaluate safety-relevant data of the small or mini vehicle and for controlling the drive module based on the evaluated safety-relevant data.

2. The drive module according to claim 1, wherein the at least one wheel comprises a first wheel and a second wheel, the at least one motor comprises a first motor and a second motor, and the at least one braking device comprises a first braking device and a second braking device, and the wheel axle carries the first and second wheels, the first and second motors, and the first and second braking devices.

3. The drive module according to claim 1, further comprising at least one activation device configured to activate the at least one braking device, wherein the evaluation and control device controls the at least one activation device to activate the at least one braking device for braking the at least one wheel.

4. The drive module according to claim 1, wherein the evaluation and control device is configured to at least one of activate or control the at least one motor to increase or decrease the drive torque.

5. The drive module according to claim 4, wherein the evaluation and control device is configured to control a switch-off of the at least one motor when the braking device is activated.

6. A small or mini vehicle comprising the drive module according to claim 1.

7. The small or mini vehicle according to claim 6, further comprising at least one sensor configured to detect a weight of at least one of a person or load of the small or mini vehicle as the safety-relevant data.

8. The small or mini vehicle according to claim 6, further comprising a position-determining device configured to determine a position of the small or mini vehicle as the safety-relevant data.

9. The small or mini vehicle according to claim 6, further comprising a person identification device configured to identify an identity at least one driver of the small or mini vehicle as the safety-relevant data.

10. The small or mini vehicle according to claim 6, further comprising an output device configured to output at least one of visual or acoustic information or a warning signal.

11. The small on mini vehicle according to claim 6, wherein at least one sensor is connected to the small or mini vehicle and is configured to send data to the evaluation and control device.

12. The small on mini vehicle according to claim 6, wherein a position-determining device that is configured to determine a position is connected to the small or mini vehicle and is configured to send data to the evaluation and control device.

13. The small on mini vehicle according to claim 6, wherein a person identification device configured to identify an identity of at least one driver of the small or mini vehicle and is configured to send data to the evaluation and control device.

14. A drive module for a vehicle, the drive module comprising:
a wheel axle;
a wheel connected to the wheel axle;
a motor for producing and applying a drive torque to the wheel;
a braking device for braking the wheel;
a sensor configured to detect safety-relevant data; and
an evaluation and control device that receives the safety-relevant data detected by the sensor and is configured to evaluate the safety-relevant data and for controlling the drive module based on the evaluated safety-relevant data.

15. The drive module as claimed in claim 14, wherein there are two of the wheels connected to the wheel axle and two of the motors, with each of the motors applying the drive torque to a respective one of the wheels, and two of the braking devices, with each of the braking devices being configured to brake a respective one of the wheels.

16. The drive module as claimed in claim 14, further comprising an activation device configured to activate the braking device, wherein the evaluation and control device controls the activation device to activate the braking device for braking the wheel.

17. The drive module as claimed in claim 14, wherein the evaluation and control device is configured to at least one of activate or control the motor to increase or decrease the drive torque.

18. The drive module as claimed in claim 14, wherein the evaluation and control device is configured to control a switching-off of the motor when the braking device is activated.

19. A vehicle comprising the drive module of claim 14, wherein the sensor is configured to detect at least one of a weight on the vehicle, a position of the vehicle, or an identity of a vehicle user.
